(19) United States
(12) Patent Application Publication
(10) Pub. No.: US 2021/0229323 A1
(43) Pub. Date: Jul. 29, 2021

(54) METHOD FOR MANUFACTURING VEHICULAR INTERIOR COMPONENT

(71) Applicant: KASAI KOGYO CO., LTD., kanagawa (JP)

(72) Inventor: Hiroki NOMURA, Hiratsuka-shi, Kanagawa (JP)

(21) Appl. No.: 17/056,850

(22) PCT Filed: Jul. 3, 2018
(86) PCT No.: PCT/JP2018/025217

§ 371 Date: Nov. 19, 2020

(51) Int. Cl. B29C 37/00; B29C 43/20; B29C 43/52

(52) U.S. Cl. CPC B29C 37/0075; B60R 13/0212; B29C 43/52; B29C 43/203

(57) ABSTRACT

To provide a vehicle-interior-component manufacturing method that can suppress damage to a designed surface of a skin and can manufacture a vehicle interior component superior in appearance quality. The method includes a first step and a second step. At the first step, a layered body is sandwiched by the forming dies so as to be subjected to hot-press forming, with the layered body including a base member, a skin, and a protection sheet that are layered over each other, the base member being made of a thermosetting resin, the skin being positioned on a side of a base member surface, and the protection sheet being positioned on a side of a skin surface. At the second step, the layered body is removed from the forming die, and then, the protection sheet is peeled.

### CROSS-REFERENCE TO RELATED APPLICATIONS

This application is a National Stage Entry application of PCT International Application No. PCT/JP2018/025217, filed on Jul. 3, 2018, the entire contents of which are hereby incorporated by reference.

### BACKGROUND

### 1. Technical Field

The present invention relates to a method for manufacturing a vehicle interior component.

### 2. Description of the Background

As a vehicle interior component represented by a door trim, a head lining (roof trim), and the like, there has been a conventionally known configuration in which a surface of a base member made of a synthetic resin is covered with a skin (Japanese Patent Application Laid-open Publication No. 2002-215169, for example). For the skin, a material including a napped surface and referred to as being of a suede form is preferred from a viewpoint of design. a cushioning property, or the like.

For example, the following technique is known as a method (first manufacturing method) for manufacturing a vehicle interior component, using a thermoplastic resin for a base member. First, the base member is heated, whereby the base member is softened, and a surface of the base member is melted. Next, in a state where the base member remains softened, and the surface of the base member remains melted, a skin is layered over the surface of the base member, and cold press is performed on the layered body by forming dies. Thereby, the base member is formed, and the skin is press-bonded to the surface of the base member.

Further, for example, the following method is known as a method (second manufacturing method) for manufacturing a vehicle interior component, using a thermosetting resin for a base member. First, the base member is formed by hot press using forming dies. Next, an adhesive is applied to a surface of the base member and a skin is then layered, and cold press is performed on the layered body by forming dies. Thereby, the skin is press-bonded to the surface of the base member.

According to each of these methods, a technique of avoiding heat application to a surface of a skin is adopted at the time of press-bonding of the skin. For this reason, even in the case of using a skin that includes a designed surface, such as a suede-form surface, easily damaged by heat, degradation in appearance quality can be suppressed.

### BRIEF SUMMARY

However, according to the first manufacturing method, heating time and press time is required, and thus, production time per product increases. Further, equipment such as a heating furnace or the like for heating the base member is necessary. In addition, when the thermoplastic resin is used, thermal behavior of a finished product becomes large, and thus, a thickness needs to be increased in order to compensate for a rigidity decrease, and there is concern over a weight increase of a product.

According to the second manufacturing method, the adhesive is applied after formation of the base member, thus leading to a weight increase and a cost increase associated with the adhesive. Further, the adhesive that has been applied to the base member needs to be prevented from adhering to the dies. Furthermore, not only the hot-press forming dies, but also the cold-press forming dies for press-bonding of the skin need to be prepared, and thus, there is a concern over a cost increase.

In view of such a matter, the present invention has been made. An object of the present invention is to provide a vehicle-interior-component manufacturing method that can suppress damage to a designed surface of a skin and can manufacture a vehicle interior component superior in appearance quality.

In order to solve such a problem, the present invention provides a method for manufacturing a vehicle interior component including a skin on a surface thereof. This manufacturing method includes a first step and a second step. At the first step, hot press is performed by a forming die, with a base member, a skin, and a protection member being layered over each other, the base member being made of a thermosetting resin, the skin being positioned on a surface side of the base member, and the protection member being positioned on a surface side of the skin. At the second step, the protection member is peeled from a surface of the skin.

Here, in the present invention, preferably, the first step is a step of hot-pressing, by the forming die, a layered body including the base member, the skin, and the protection member that are layered over each other in advance, and the second step is a step of removing the layered body from the forming die, and then peeling the protection member.

Alternatively, in the present invention, preferably, the first step is a step of hot-pressing a layered body by the forming die whose surface contacting with the skin is covered with the protection member, with the layered body including the base member and the skin that are layered over each other in advance, and the second step is a step of removing the layered body from the forming die, and thereby peeling the protection member.

According to the manufacturing method of the present invention, damage to a designed surface of a skin can be suppressed, and thus, a vehicle interior component superior in appearance quality can be manufactured.

### BRIEF DESCRIPTION OF DRAWINGS

FIG. 1 is a plan view schematically illustrating a head lining according to the present embodiment.

FIG. 2 is a cross-sectional view schematically illustrating a main part of a roof portion.

FIG. 3A. FIG. 3B, and FIG. 3C are each an illustration representing a method for manufacturing the head lining.

FIG. 4A, FIG. 4B, and FIG. 4C are each an illustration representing a modified example of the method for manufacturing the head lining.

### DETAILED DESCRIPTION

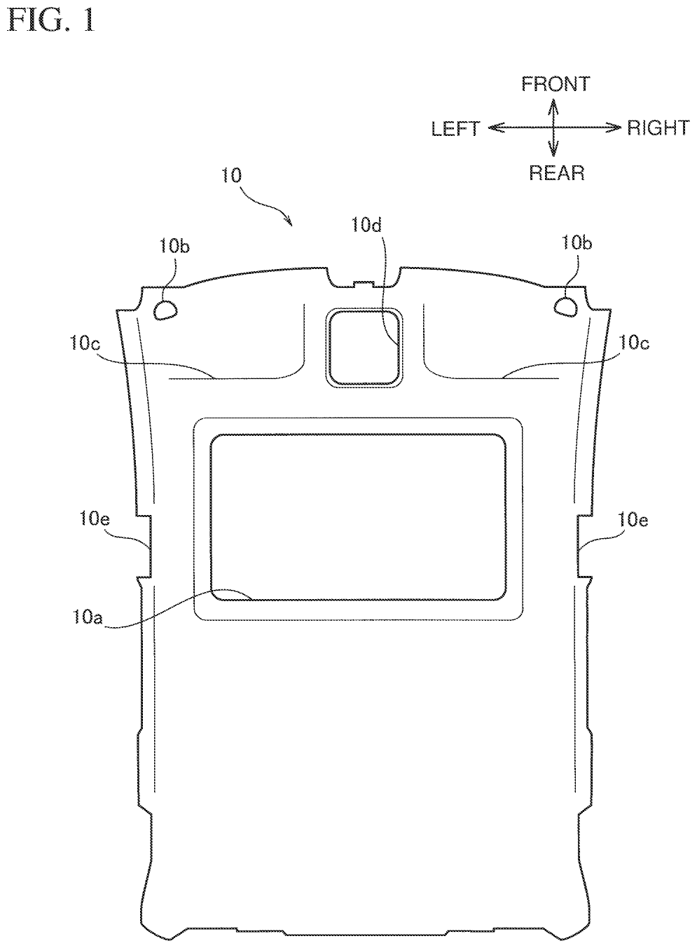

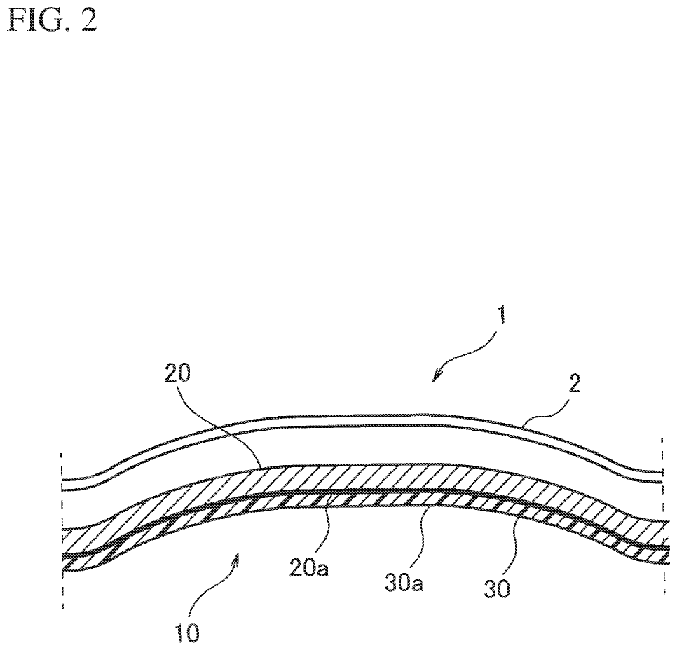

The following describes the case where a vehicle interior component according to the present embodiment is applied to a head lining 10. Here, FIG. 1 is a plan view schematically illustrating the head lining 10 according to the present embodiment, and FIG. 2 is a cross-sectional view schematically illustrating a main part of a roof portion 1 of a vehicle.

The roof portion 1 of the vehicle includes a roof panel 2 as a vehicle body panel. To a vehicle interior side in the roof panel 2, the head lining 10 is attached. The head lining 10 is arranged in a state of being close to the roof panel 2, and covers the vehicle interior side in the roof panel 2.

At a center position in the head lining 10, a sunroof opening 10a is provided. The sunroof opening 10a conforms to a sunroof unit (not illustrated) that opens and closes an opening formed in the roof panel 2. At a front position in the head lining 10, respective sun visor openings 10b and respective accommodation portions 10c are provided in association with a driver's seat and a front passenger seat. The sun visor openings 10b are provided for attaching sun visors (not illustrated) to the roof panel 2. The accommodation portions 10c are shaped for accommodating the sun visors. At a center (between the left and right accommodation portions 10c) of the front position in the head lining 10, a room lamp opening 10d is provided for attaching a room lamp (not illustrated) to the roof panel 2. Further, at left and right edge portions of the head lining 10, respective grip portions 10e are provided for handling the head lining 10 at the time of manufacturing.

The head lining 10 includes a base member 20 and a skin 30, and has a layered structure in which these are layered over each other. The base member 20 is a member that forms a basis of the head lining 10, and is a sheet-shaped member made of urethane foam. The skin 30 is adhered to a base member surface 20a (the surface belonging to the base member 20 and positioned on a vehicle interior side), and forms a designed surface on the vehicle interior side. From a standpoint of design, a cushioning property, or the like, the skin 30 is made of a suede-form material, such as a wool material, that includes a napped surface.

Note that the head lining 10 may have a configuration in which a reinforcement sheet and a back-surface film are further layered over each other on a back-surface side in the base member 20. The reinforcement sheet is a sheet that reinforces the base member 20, and is made of a fiber material such as a glass mat or a glass fiber. The back-surface film is an air-impermeable film made of a rigid resin such as a polypropylene resin. Further, in the back-surface film, on a side of the roof panel 2, a far-infrared reflection layer may be provided. The far-infrared reflection layer shields far-infrared rays by means of reflection, and can be formed as a metal film, a metal foil, or the like. In addition, in the far-infrared reflection layer, on a side of the roof panel 2, an antioxidant coating layer may be provided. The antioxidant coating layer suppresses oxidation of the metal surface, and can be formed by application of an epoxy resin, an acrylic resin, or the like.

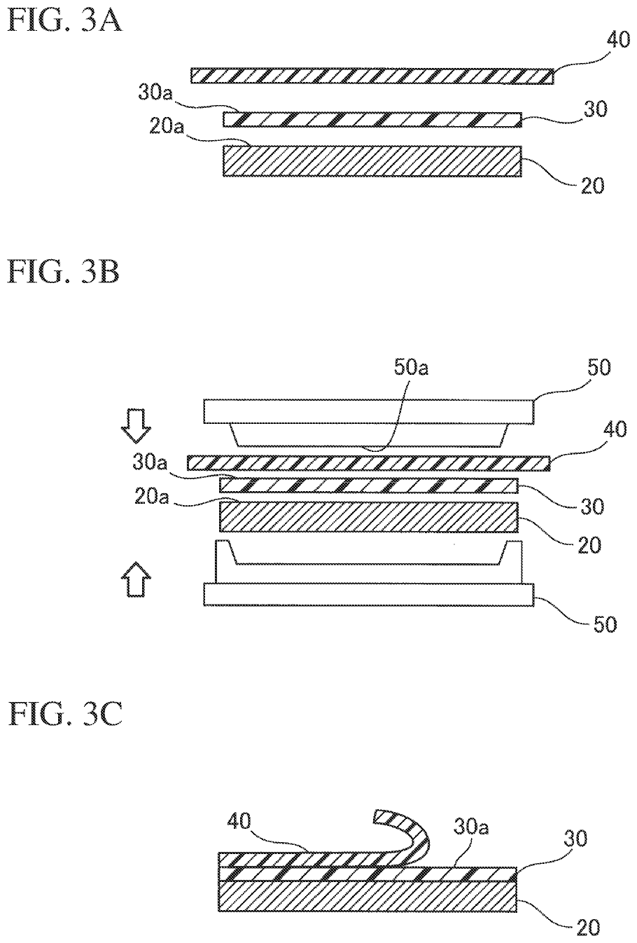

The following describes a method for manufacturing the head lining 10 according to the present embodiment. Here. FIG. 3A, FIG. 3B, and FIG. 3C are each an illustration representing the method for manufacturing the head lining 10.

First, the base member 20 is prepared. The base member 20 is formed of a thermosetting resin. For example, the base member 20 is formed by slicing urethane foam into a sheet having a required plate thickness. Next, on a side of the base member surface 20a, the skin 30 and a protection sheet 40 are layered over each other in this order, and thereby, a layered body is composed (FIG. 3A). A surface dimension of the protection sheet 40 is set to be equal to or larger by approximately one stage than a surface dimension of the skin 30.

Next, the layered body is hot-pressed by forming dies 50, whereby the base member 20 is formed into a required shape, and the skin 30 is press-bonded to the base member surface 20a (FIG. 3B).

Lastly, the layered body is removed from the forming dies 50. Then, the protection sheet 40 layered over a skin surface 30a is peeled from the skin 30 (FIG. 3C).

By the above-described series of steps, the head lining 10 is manufactured.

Next, description is made on the protection sheet 40 that is one of features of the present embodiment. The protection sheet 40 is interposed between a die surface 50a and the skin surface 30a at the time of hot press forming performed by the forming dies 50. The protection sheet 40 is a sheet-shaped protection member for suppressing thermal damage to the skin surface 30a by restricting the skin surface 30a from directly contacting with the die surface 50a that becomes high in temperature. In order to fulfill such a function, the following properties are required for the protection sheet 40.

<Required Properties>
(1) Weight: 10 to 1000 g/m²
(2) Thickness: 0.001 to 30 mm
(3) Thermal conductivity: 0.01 to 0.3 W/(m*K)
(4) Air permeability: 0 to 600 cm³/(cm²*sec)

The requirement concerning the weight is made in consideration of conveyance performance of the protection sheet 40 at the time of manufacturing. The requirements concerning the thickness, the thermal conductivity, and the air permeability are made in consideration of transmitting, to the base member 20, heat necessary for press-bonding of the skin 30 while suppressing an appearance defect (gloss or the like) caused by heat acting from the mold surface 50a to the skin surface 30a.

A material satisfying such required properties can be urethane foam, for example. However, as long as the above-described required properties are satisfied, there is no problem even in the case of using PET fiber, polyamide fiber, a resin film, or the like.

More preferably, as the protection sheet 40, urethane foam having the following properties can be used.

<Required Properties>
(1) Weight: 50 to 60 g/m²
(2) Thickness: 2 mm
(3) Thermal conductivity: 0.043 W/(m*K)
(4) Air permeability: 400 cm/(cm²*sec)

By satisfying these required properties, the protection sheet 40 can suppress heat of the mold surface 50a from directly acting on the skin surface 30a. Thereby, a nap on the surface of the skin 30 can be prevented from falling due to influence of heat of the forming die 50, and appearance abnormality such as gloss can be prevented from occurring. Meanwhile, the protection sheet 40 can transmit, to the base member 20, heat required for press-bonding of the skin 30. Since heat transmission to the base member 20 is not hindered, the skin 30 can be press-bonded with high reliability.

Further, the protection sheet 40 preferably has the following properties.
(5) Compression strength: 4.0 to 7.0 kPa
(6) Tensile stress: 1.0 to 5.0 N
(7) Breaking strength: 9.0 to 13.0 N
(8) Friction coefficient: 1.0 to 3.0

Here, the compression strength is a strength when a predetermined test piece (square (50×50 mm)) is compressed by 10% to 50%. The tensile stress is a stress when a predetermined test piece (rectangle (50×200 mm)) is stretched by 10% to 40%. The breaking strength is a strength concerning a predetermined test piece (rectangle (50×200 mm)). The friction coefficient is a coefficient in relation to the skin 30.

The protection sheet 40 satisfying these properties enables implementation of the protection sheet 40 well compatible with the skin 30. In hot-press forming, the base member 20 is formed in accordance with shaping required for the head lining 10. At this time, the skin 30 and the protection sheet 40 pressed together with the base member 20 need to be deformed along the shape of the base member 20, and in this case, the protection sheet 40 is required to have elasticity higher than that of the skin 30. This is because the protection sheet 40 stretches and contracts accompanying deformation of the skin 30 at the time of hot-press forming, and thereby, creases, twists, and the like can be prevented from occurring. As a result, the designed surface of the skin 30 can be kept in a satisfactory condition. In addition, the protection sheet 40 contacts with the skin 30 with appropriate friction, whereby at the time of hot-press forming, the protection sheet 40 follows the skin 30 so as to be pulled by the skin 30, and creases, twists, and the like can be prevented from occurring. Thereby, the designed surface of the skin 30 can be kept in a satisfactory condition.

As described above, the method for manufacturing the head lining 10 according to the present embodiment includes a first step and a second step. At the first step, a layered body is sandwiched by the forming dies 50 so as to be subjected to hot-press forming, with the layered body including the base member 20, the skin 30, and the sheet-shaped protection sheet 40 that are layered over each other, the base member 20 being made of a thermosetting resin, the skin 30 being positioned on a side of the base member surface 20a, and the protection sheet 40 being positioned on a side opposite to the base member 20 with respect to the skin 30. At the second step, the layered body is removed from the forming dies 50, and then, the protection sheet 40 is peeled.

According to this manufacturing method, the head lining 10 can be manufactured by a simple technique of merely adding the protection sheet 40 in the hot-press forming. Thereby, a dedicated die for press-bonding of the skin 30 does not need to be prepared, and thus, manufacturing can be performed with simple equipment while a cost increase is suppressed. Further, a dedicated step for press-bonding of the skin 30 is unnecessary, and thus, manufacturing time can be shortened. In addition, an adhesive does not need to be applied, and thus, there is no need for concern over adhering of an adhesive. As a result, an increase in cost at the time of manufacturing can be suppressed, and weight reduction of the head lining 10 can be achieved.

In the present embodiment, by satisfying the above-described property requirements, the protection sheet 40 can further achieve the following function and advantageous effect. First, in the present embodiment, the skin 30 is press-bonded to the base member 20 by the hot-press forming. Here, while a temperature of the surface of the forming die 50 becomes a high temperature of approximately 100 to 140° C. interposing the protection sheet 40 can prevent the forming die 50 and the skin 30 from directly contacting with each other. Thereby, a nap on the surface of the skin 30 can be prevented from falling due to influence of heat of the forming die 50, appearance abnormality such as gloss can be prevented from occurring, and the design can be prevented from being degraded.

Meanwhile, the protection sheet 40 does not completely hinder heat transmission, and accordingly, does not hinder press-bonding between the skin 30 and the forming die 50.

In the present embodiment, the skin 30 of a wool material is described above. However, the manufacturing method according to the present embodiment can be applied for various skins 30 whose appearances become abnormal due to influence of heat of the forming die 50. Examples of such skins 30 include a silk material, a cashmere material, a polyester material, a rayon material, a material including black design, a printed material, and a knit material.

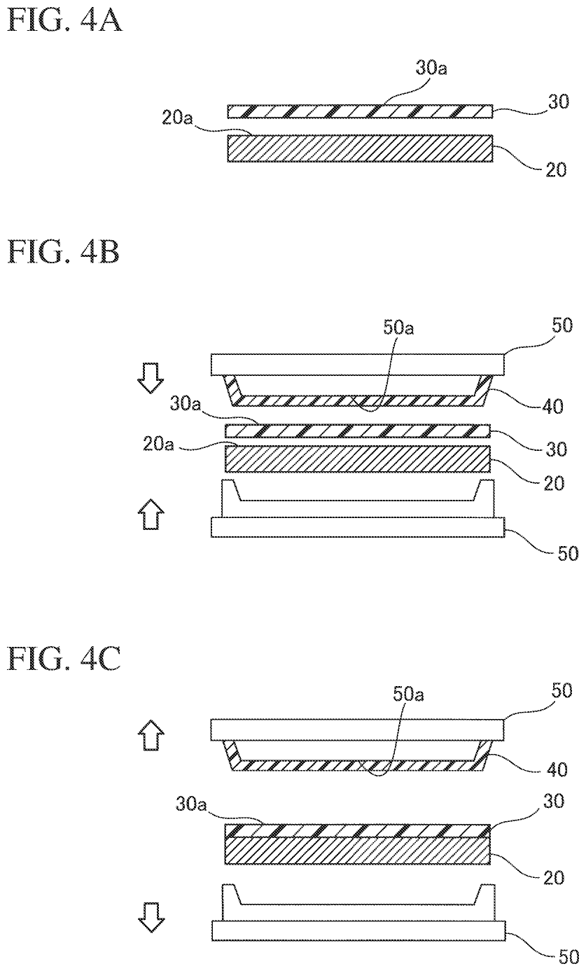

Further, in the above-described embodiment, hot-press forming is performed on the layered body including the base member 20, the skin 30, and the protection sheet 40 that are layered over each other. However, it suffices that hot-press forming is performed in a state where the base member 20, the skin 30, and the protection sheet 40 are layered over each other such that the protection sheet 40 is interposed between the skin surface 30a and the die surface 50a. For example, as illustrated in FIG. 4A, FIG. 4B, and FIG. 4C, by the forming die 50 whose surface contacting with the skin 30 is covered with the protection sheet 40, hot-press forming is performed on a layered body including the base member 20 and the skin 30 that are layered over each other in advance. In this case, the protection sheet 40 is peeled by removing the layered body from the forming dies 50.

Although the method for manufacturing the head lining as a vehicle interior component according to the embodiment of the present invention is described above, as a matter of course, the present invention is not limited to the above-described embodiment, and various modifications can be made within the scope of the invention. The present invention can be widely applied to not only a head lining but also other vehicle interior components, such as a door panel, that decorate a vehicle interior.

### REFERENCE SIGNS LIST

1 Roof portion
2 Roof panel
3 Skin
10 Head lining
10a Sunroof opening
10b Sun visor opening
10c Accommodation portion
10d Room lamp opening
10e Grip portion
20 Base member
20a Base member surface
30 Skin
30a Skin surface
50 Protection sheet
50 Forming die
50a Die surface

1. A method for manufacturing a vehicle interior component including a skin on a surface thereof, the method comprising:
a first step of performing hot press by a forming die, with a base member, a skin, and a protection member being layered over each other, the base member being made of a thermosetting resin, the skin being positioned on a surface side of the base member and having a cushioning property, and the protection member being positioned on a surface side of the skin; and
a second step of peeling the protection member from a surface of the skin.

2. The method for manufacturing a vehicle interior component according to claim 1, wherein
the skin is made of a material including a napped surface, polyester material, or rayon material,
the first step is a step of hot-pressing, by the forming die, a layered body including the base member, the skin, and the protection member that are layered over each other in advance, and
the second step is a step of removing the layered body from the forming die, and then peeling the protection member.

3. The method for manufacturing a vehicle interior component according to claim 1, wherein
the skin is made of a material including a napped surface, polyester material, or rayon material,
the first step is a step of hot-pressing a layered body by the forming die whose surface contacting with the skin is covered with the protection member, with the layered body including the base member and the skin that are layered over each other in advance, and
the second step is a step of removing the layered body from the forming die, and thereby peeling the protection member.
